(19) United States
(12) Patent Application Publication
(10) Pub. No.: US 2006/0043706 A1
(43) Pub. Date: Mar. 2, 2006

(54) Occupant protection system

(75) Inventors: Noriyuki Kosugi, Higashioumi-shi (JP); Atsushi Noguchi, Moriyama-shi (JP); Akifumi Takedomi, Higashioumi-shi (JP)

Correspondence Address: KANESAKA BERNER AND PARTNERS LLP, SUITE 300, 1700 DIAGONAL RD, ALEXANDRIA, VA, 22314-2848, US

(73) Assignee: TAKATA CORPORATION, Tokyo (JP)

(21) Appl. No.: 11/202,158

(22) Filed: Aug. 12, 2005

(30) Foreign Application Priority Data
Aug. 31, 2004 (JP) 2004-252630

(51) Int. Cl. B60R 21/16

(52) U.S. Cl. 280/730.2

(57) ABSTRACT

An occupant protection system includes a side air bag to be inflated at a side of an occupant in a vehicle, a curtain sheet situated adjacent to a window opening at the side of the occupant, and an actuation device attached to the curtain sheet. The curtain sheet is generally located away from a position covering the window opening. The actuation device is operated in an emergency situation, to cover the window opening by the curtain sheet to support the side air bag.

### BACKGROUND OF THE INVENTION AND RELATED ART STATEMENT

The present invention relates to an occupant protection system for protecting an occupant in a vehicle when the vehicle is involved in a side collision or turns on a side.

A side air bag device and curtain air bag device are known as an occupant protection system for protecting an occupant by preventing the occupant from hitting a side door when a vehicle is involved in a side collision or turns on a side (for example, see Patent References 1 and 2). In this specification, turning on a side includes a rollover.
Patent Reference 1: Japanese Patent Application Publication (Kokai) No. 10-175499
Patent Reference 2: Japanese Patent Application Publication (Kokai) No. 2000-62562

An object of the present invention is to provide an occupant protection system having a side air bag device and a curtain sheet disposed in a limited space in a vehicle for effectively protecting an occupant in an event of a side collision or turning on a side.

Further objects and advantages of the invention will be apparent from the following description of the invention.

### SUMMARY OF THE INVENTION

In order to attain the objects described above, according to a first aspect of the present invention, an occupant protection system includes a side air bag to be inflated at a side of an occupant of a vehicle. The occupant protection system further includes a curtain sheet situated away from a position covering a window at a side of a seat in a normal state and to be deployed to cover the window from a cabin side of the vehicle in an emergency state.

According to a second aspect of the invention, in the occupant protection system in the first aspect, the side air bag is inflated at least at a side of a portion between a hip and a head of the occupant.

According to a third aspect of the invention, in the occupant protection system in one of the first and second aspects, the curtain sheet has an upper portion secured to a chassis above the window. A pulling device pulls a lower portion of the curtain sheet to be deployed to cover the window.

According to a fourth aspect of the invention, in the occupant protection system in the third aspect, a linear member is mounted along the lower portion of the curtain sheet. One end of the linear member is fixed to the chassis, and the pulling device pulls the other end of the linear member.

According to a fifth aspect of the invention, in the occupant protection system in one of the third and fourth aspects, the pulling device is provided with a stopper for preventing the pulling device from retracting after being pulled.

According to a sixth aspect of the invention, in the occupant protection system in one of the first to fifth aspects, the curtain sheet is situated between the side air bag and the window when the side air bag is completely inflated and the curtain sheet is completely deployed.

In the present invention, when a vehicle having the occupant protection system is involved in a side collision or turns on a side, the curtain sheet is deployed along the window at a side of the seat, and the side air bag is inflated on a cabin side of the curtain sheet, so that the side air bag receives the occupant to absorb an impact. Even when the window is open or broken, the curtain sheet prevents the side air bag from moving out of the window, thereby effectively absorbing the impact. The curtain sheet also holds the occupant inside the cabin of the vehicle.

In the present invention, the occupant protection system includes the curtain sheet instead of a curtain air bag device. Accordingly, it is possible to retain the occupant protection system in a space in the vehicle smaller than that of a curtain air bag device.

In the present invention, the occupant protection system preferably includes the side air bag to be inflated at least at a side from the hip to the head of the occupant. Accordingly, it is possible to receive an entire side portion of the occupant sitting on the seat with the side air bag, thereby effectively protecting the occupant.

In the present invention, the curtain sheet may have the upper portion secured to the chassis above the window, and the pulling device may pull the lower portion of the curtain sheet, so that the curtain sheet is deployed to cover the window. When the pulling device pulls the curtain sheet, it is possible to quickly deploy the curtain sheet even when the curtain sheet slides on a pillar of the chassis.

In the present invention, the linear member may be provided along the lower portion of the curtain sheet. One end of the linear member is fixed to the chassis, and the pulling device pulls the other end of the linear member. Accordingly, it is possible to stretch the curtain sheet with the linear member so that the lower portion is pulled with a sufficient tensile force (so that the lower portion is tightly stretched).

In the present invention, the pulling device may have the stopper for preventing the curtain sheet from retracting after the curtain sheet is pulled. Accordingly, the deployed curtain sheet is held under high tension, thereby effectively receiving the side air bag and the occupant for long time.

### BRIEF DESCRIPTION OF THE DRAWINGS

FIGS. 1(a) and 1(b) are perspective views showing an occupant protection system according to an embodiment of the present invention;

FIGS. 2(a) and 2(b) are perspective views showing an occupant protection system according to another embodiment of the present invention; and

FIGS. 3(a) and 3(b) are perspective views showing an occupant protection system according to a further embodiment of the present invention.

### DETAILED DESCRIPTION OF PREFERRED EMBODIMENTS

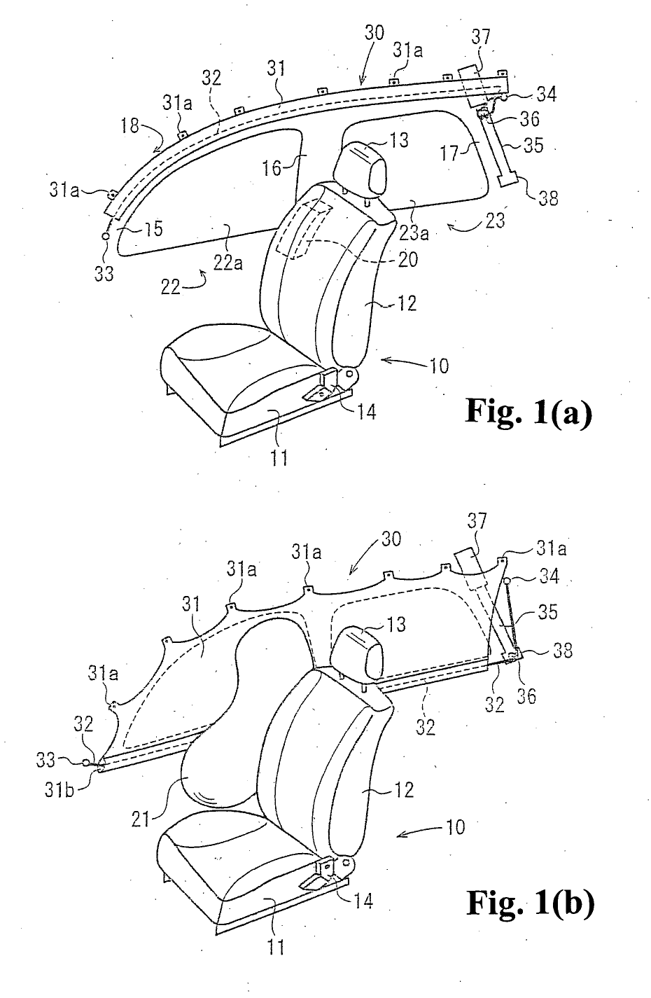

Hereunder, embodiments of the present invention will be described with reference to the drawings. FIGS. 1(a) and 1(b) are perspective views of a front seat in a car provided with an occupant protection system according to an embodiment, respectively. FIG. 1(a) shows a state before a side air bag is inflated and a curtain sheet is deployed, and FIG. 1(b) shows a state after the side air bag is inflated and the curtain sheet is deployed.

As shown in FIGS. 1(a) and 1(b), a seat 10 in the car includes a seat cushion 11, a seat back 12, and a headrest 13. A shoulder anchor (not shown) is provided on a B-pillar 16, and a shoulder belt is hung on the shoulder anchor. The shoulder belt is attached to a buckle 14 via a tongue. A side air bag device 20 includes a side bag 21 to be inflated along a front door 22 and an inflator (not shown) for inflation, and is provided at the front door 22 or the seat 10 (the seat 10 in the embodiment).

A curtain sheet device 30 extends from an A-pillar 15 of the car to a C-pillar 17 through a roof side rail 18. In a case of a side collision or rolling, a curtain sheet 31 is deployed between the A-pillar 15 and the C-pillar 17 to cover windows 22a and 23a of the front door 22 and a rear door 23. The curtain sheet 31 is folded up in an elongated form, and is disposed along the roof side rail 18 while a shape is held by, for example, a breakable tape. The curtain sheet 31 is covered with a roof head lining (not shown).

A plurality of lugs 31a projects from an upper portion of the curtain sheet 31. The lugs 31a are fastened to the A-pillar 15 and the roof side rail 18 by, for example, bolts or rivets. A lower portion of the curtain sheet 31 is turned up and sewn to form a tunnel-shaped rope extending portion 31b. A rope 32 extends through the rope extending portion 31b. A front end of the rope 32 is connected to the bottom of the A-pillar 15 via a rope anchor 33, and a rear end thereof is connected to the top of the C-pillar 17 via a rope anchor 34.

In the embodiment, the curtain sheet device 30 includes a guide rail 35 mounted on the C-pillar 17 as a pulling device for pulling the curtain sheet 31 downwardly and extending the curtain sheet 31 vertically; a slider 36 slidable along the guide rail 35; an actuator 37 for moving the slider 36 with a pressure of gas; and a one-way clutch 38 provided at the bottom of the guide rail 35. The actuator 37 includes a gas generator, and a multistage piston (not shown) extending along the guide rail 35 by a pressure of gas from the gas generator. When the gas generator is activated, the piston extends to push the slider 36, so that the slider 36 moves along the guide rail 35. When the slider 36 reaches a lower end of the guide rail 35, the slider 36 is latched with the one-way clutch 38, thereby being prevented from retracting upwardly.

The rear end of the rope 32 drawn out of a rear end of the rope extending portion 31b is hooked to the slider 36 and connected to the rope anchor 34.

When the car provided with the side air bag device 20 and the curtain sheet device 30 thus constructed is involved in a side collision or turns on its side, the actuator 37 and the inflator of the side air bag device 20 are activated. Upon the activation of the actuator 37, the slider 36 moves along the guide rail 35, and pushes down the rear portion of the rope 32, thereby stretching the curtain sheet 31, as shown in FIG. 1(b). The curtain sheet 31 pushes a side edge of the roof head lining open, and stretches downwardly along the cabin sides of the windows 22a and 23a. In a state in which the slider 36 is latched by the one-way clutch 28, the rope 32 is tightly extended between the slider 36 and the rope anchor 33, and the curtain sheet 31 covers the windows 22a and 23a of the doors 22 and 23.

Upon the activation of the inflator of the side air bag device 20, the side air bag 21 is inflated at a side of a part between the hip and head of an occupant on the seat 10. The side air bag 21 is inflated and situated on the cabin side of the deployed curtain sheet 31. Since the inflated side air bag 21 receives the occupant from the side, the impact applied to the occupant is absorbed.

The deployed curtain sheet 31 covers the windows 22a and 23a, even when the window glasses of the doors 22 and 23 are open or broken. Accordingly, the occupant remains inside the car. The deployed curtain sheet 31 also backs up the inflated side air bag 21, and prevents the side air bag 21 from moving toward the outside of the car.

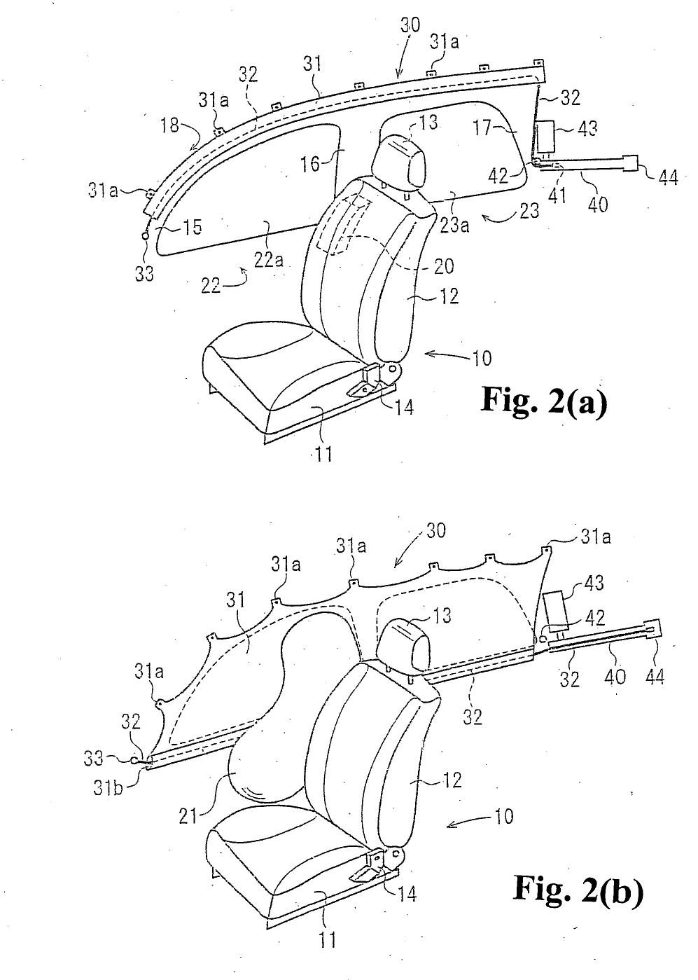

While the multistage actuator 37 using the gas generator as a driving power source is adopted in the embodiment, a piston-shaped slider may be directly moved by the blow pressure of gas from the gas generator. FIGS. 2(a) and 2(b) show an example of such a method. A cylinder-shaped guide rail 40 extends in the front-rear direction of the vehicle body at the bottom of a C-pillar 17. A piston-shaped slider 41 is placed inside a guide rail 40. A rear end of a rope 32 is connected to the slider 41. At least the rear end of the rope 32 is heat resistant. An end of the rope 32 is guided into the guide rail 40 by a sheave 42.

A front end of the guide rail 40 is closed by a head end plate. The head end plate has an insertion hole (not shown) for inserting the rope 32. A gas generator 43 is connected to the guide rail 40 to supply gas between the head end plate and the slider 41. A one-way clutch 44 is provided at a rear end of the guide rail 40.

When the gas generator 43 is activated, the slider 41 moves rearward along the guide rail 40 until it is latched with the one-way clutch 44, as shown in FIG. 2(b). Consequently, the rope 32 is tightly deployed, and the curtain sheet 31 is deployed to cover windows 22a and 23a. A side air bag 20 operates in a manner similar to that in the embodiment described above. In this embodiment, advantages similar to those in the above embodiment are obtained.

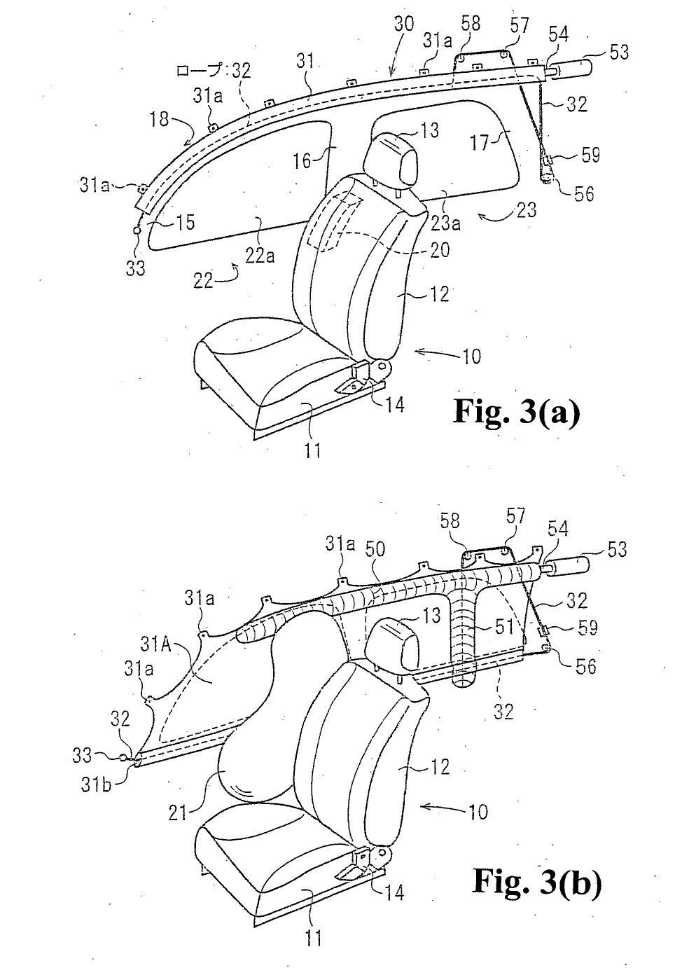

While the guide rail 40 extends laterally in FIGS. 2(a) and 2(b), the guide rail 40 may extend vertically so that the end thereof at the one-way clutch 44 is placed on the upper portion. FIGS. 3(a) and 3(b) show a structure according to a further embodiment, in which expandable chambers 50 and 51 are provided in a curtain sheet 31A. A gas generator 53 supplies gas to the expandable chambers 50 and 51 to be inflated, and a rope 32 is pulled by the force of inflation.

As shown in FIG. 3(b), the chamber 50 extends in the front-rear direction of the vehicle body along an upper portion of the curtain sheet 31A. The gas generator 53 is connected to a rear end of the chamber 50 via a duct 54. The chamber 51 is branched from the chamber 50 at a longitudinal midpoint, extends downwardly through almost the center of a window 23a, and reaches a lower portion of the curtain sheet 31A.

Sheaves 56, 57, and 58 are provided at the bottom of the C-pillar 17 in the rear of a roof side rail 18. A rope 32 extending from a rear end of a rope extending portion 31b is hung on the sheave 56, is hung on the sheaves 57 and 58 provided above the window 23a, and is guided into the chamber 51. The rope 32 extends inside the chamber 51, and is connected at the tail end to the curtain sheet 31A near the lower end of the chamber 51. A one-way rope clutch 59 is provided between the sheaves 56 and 57 to allow the rope 32 only to move from the sheave 56 to the sheave 57.

When the gas generator 53 is activated, gas blown from the gas generator 53 flows straight, and first inflates the chamber 50. A roof lining covering the curtain sheet 31A is thereby pushed open, and a space is formed between the roof lining and a side portion of the vehicle body. The gas flows from the chamber 50 into the chamber 51, and the chamber 51 expands downwardly through the space. A portion of the curtain sheet 31A adjoining the chamber 51 also stretches downwardly through the space while being dragged by the chamber 51. With the downward expansion of the chamber 51, the tail end of the rope 32 is pulled downwardly, and the entire curtain sheet 31A is deployed downwardly through the space. Finally, in a stretch finished state shown in FIG. 3(b), the curtain sheet 31A covers the windows 22a and 23a. In this state, the rope 32 is latched with the rope clutch 59, and is held under high tension.

Other structures in FIGS. 3(a) and 3(b) are similar to those in the above embodiments, and the same reference numerals denote the same components.

The embodiment provides advantages similar to those in the above embodiments. The embodiment is also advantageous in that the chamber 51 receives the head of the occupant on a rear seat and absorbs an impact.

The above embodiments are exemplary embodiments of the present invention, and the present invention may also include embodiments other than the illustrated embodiments. For example, a wire, a belt, a soft resin rod, or a tube may be used as a linear member, instead of the rope. The pulling device is not limited to the one using the gas generator as a power source, and, for example, a motor and a linear solenoid may be used as the power source.

The disclosure of Japanese Patent Application No. 2004-252630, filed on Aug. 31, 2004, is incorporated in the application.

While the invention has been explained with reference to the specific embodiments of the invention, the explanation is illustrative and the invention is limited only by the appended claims.

What is claimed is:

1. An occupant protection system comprising:
a side air bag to be inflated at a side of an occupant in a vehicle,
a curtain sheet situated adjacent to a window opening at the side of the occupant, said curtain sheet being generally located away from a position covering the window opening, and
an actuation device attached to the curtain sheet, said actuation device being operated in an emergency situation, to cover the window opening by the curtain sheet to support the side air bag.

2. An occupant protection system according to claim 1, wherein said side air bag has a size, upon inflation, to cover at least a portion between a hip and a head of the occupant.

3. An occupant protection system according to claim 1, wherein said actuation device is a pulling device for pulling a lower portion of the curtain sheet to cover the window opening, said curtain sheet having an upper portion adapted to be fixed to a chassis of the vehicle above the window opening.

4. An occupant protection system according to claim 3, further comprising a linear member mounted along the lower portion of the curtain sheet, said linear member having one end fixed to the chassis and the other end pulled by the pulling device.

5. An occupant protection system according to claim 3, wherein said pulling device includes a stopper for preventing the curtain sheet from retracting after being pulled.

6. An occupant protection system according to claim 1, wherein said curtain sheet is situated between the side air bag and the window opening when the side air bag is completely inflated and the curtain sheet is completely deployed.
